(19) United States
(12) Patent Application Publication
(10) Pub. No.: US 2015/0253574 A1
(43) Pub. Date: Sep. 10, 2015

(54) Modular and Convertible Virtual Reality Headset System

(71) Applicant: Ion Virtual Technology Corporation, Boise, ID (US)

(72) Inventor: Daniel Thurber, Boise, ID (US)

(73) Assignee: ION VIRTUAL TECHNOLOGY CORPORATION, Boise, ID (US)

(21) Appl. No.: 14/641,411

(22) Filed: Mar. 8, 2015

Related U.S. Application Data
(60) Provisional application No. 61/950,651, filed on Mar. 10, 2014.
(60) Provisional application No. 61/994,544, filed on May 16, 2014.
(60) Provisional application No. 62/089,388, filed on Dec. 9, 2014.

(51) Int. Cl. G02B 27/01

(52) U.S. Cl. CPC G02B 27/0172; G02B 2027/0134

(57) ABSTRACT

A modular and customizable virtual reality headset system comprises an optional mobile device case, a support module, a device module with a dock for a mobile device or for the mobile device case, and a lens module. The modules preferably removably attach together with nesting extensions and a removable plug that extends through aligned holes defined by the extensions. The support module comprises one or more walls, optional corners, and optional edges. The system further comprises control and processing components, one or more input devices, a comfort module, and a strap. Additional features include a microphone, headphones, a camera, a display, communication components, motion sensors and movement trackers, filters, battery chargers, and warning devices. The basic components of the VR headset system and the optional features and components are preferably all customizable and upgradeable to match the user's aesthetic preferences and technical requirements.

### CROSS-REFERENCE TO RELATED APPLICATIONS

This application claims the benefit of co-pending provisional U.S. Application No. 61/950,651 filed Mar. 10, 2014 and co-pending provisional U.S. Application No. 61/994,544 filed May 16, 2014, and co-pending provisional U.S. Application No. 62/089,388 filed Dec. 9, 2014.

### FIELD OF INVENTION

This invention relates to virtual reality environments and head mounted displays. More particularly, this device relates to modular and convertible virtual reality headset system for customizing the fit, intended use, and additional features to accommodate its use with mobile devices.

### BACKGROUND

Virtual reality (VR) systems are gaining in popularity and providing useful for many applications including gaming, entertainment, advertising, architecture and design, medical, sports, aviation, tactical, engineering, and military applications. Most VR systems use personal computers with powerful graphics cards to run software and display the graphics necessary for enjoying an advanced virtual environment. To display virtual reality environments, many systems use head-mounted displays (HMDs).

Many HMDs include two displays, one for each eye, to create a stereoscopic effect and give the illusion of depth. HMDs also can include on-board processing and operating systems such as Android to allow application to run locally, which eliminates any need for physical tethering to an external device. Sophisticated HMDs incorporate positioning systems that track the user's head position and angle to allow a user to virtually look around a VR environment simply by moving his head. Sophisticated HMDs may also track eye movement and hand movement to bring additional details to attention and allow natural interactions with the VR environment.

While traditional HMDs include dedicated components, interest is growing to develop an HMD that incorporates a user's own mobile device such as smart phones, tablets, and other portable or mobile devices having video displays. In order to create an immersive VR environment, however, the HMD must be sized, configured, and constructed in specific way for use with a particular mobile device. Current HMDs fail to effectively accommodate mobile devices and do not allow the user to customize the HMD as needed or desired. Accordingly, it would be desirable to provide an HMD or VR headset that cooperates with a mobile device. Moreover, it would be desirable to provide an HMD or VR headset that cooperates with a mobile device in a case without having to remove the mobile device from the case. Additionally, it would be desirable to provide an HMD or VR headset that allows for customization and upgrading as needed or desired.

### SUMMARY OF THE INVENTION

A modular and customizable virtual reality (VR) headset system comprises one or more modular segments. The modular segments preferably include a headset that cooperates directly with a mobile device or that cooperates with a dedicated mobile device case such that the mobile phone can be attached to the headset without having to remove the case. The headset comprises a device module with a base and a receptacle or dock defined by the base for accommodating the mobile device case or a mobile device directly, a support module with inner and outer shells or with one or more walls and optional corners, edges, and covers, a lens module with a lens plate, a first lens, a second lens, a first lens cup, a second lens cup, a first lens modifier, a second lens modifier, and a lens adjuster, a comfort module, and a strap. In order to facilitate customization, specific uses, and upgrades, the modular segments cooperate and are secured together with components that allow the segments to be removed and replaced. In a preferred embodiment, the components attach with nesting extensions and a removable plug, key, or insert. Additional features can also be included such as control and processing components, a microphone, headphones, a video camera, a heads-up display, communication components, input devices, motion sensors and movement trackers, filters, battery chargers, and warning devices. The basic components of the VR headset system and the optional features and components are preferably all customizable and upgradeable to match the user's aesthetic preferences and technical requirements.

### BRIEF DESCRIPTION OF THE DRAWINGS

FIG. 1 is a top schematic view of an embodiment of the virtual reality headset system of the present invention.

FIG. 2 is a front schematic view of an embodiment of the base component of the virtual reality headset system of the present invention.

FIG. 3 is a perspective exploded view of an embodiment of the virtual reality headset of the present invention.

FIG. 4 is a perspective exploded view of a second embodiment of the virtual reality headset of the present invention.

FIG. 5 is a top cutaway view of the second embodiment of the virtual reality headset of the present invention that illustrates a lens system of the present invention.

FIG. 6 is an illustration of examples of locks appropriate for use with the virtual reality headset of the present invention.

FIG. 7 is a cutaway view of the second embodiment of the virtual reality headset of the present invention that illustrates the preferred lens system of the present invention.

FIG. 8 is a perspective partial exploded view of a third embodiment of the virtual reality headset of the present invention.

FIG. 9 is a perspective view of the third embodiment of the virtual reality headset of the present invention.

FIG. 10 is a perspective view of the device module and lens module of the third embodiment of the virtual reality headset of the present invention.

FIG. 11A is a perspective view of the inner shell of the support module of the third embodiment of the virtual reality headset of the present invention.

FIG. 11B is a perspective view of the outer shell of the support module of the third embodiment of the virtual reality headset of the present invention.

FIG. 12 is a front view of the device module of the third embodiment of the virtual reality headset of the present invention.

FIG. 13 is a side view of the device module and an open lock of the third embodiment of the virtual reality headset of the present invention.

FIG. 14 is a side view of a mobile device positioned in the device module of the third embodiment of the virtual reality headset of the present invention.

FIG. 15 is a perspective view of an embodiment of a strap connector for use with the virtual reality headset of the present invention.

FIG. 16A is a side view of an open position of an embodiment of an alternative lock of the third embodiment of the present invention.

FIG. 16B is a side view of the lock shown in FIG. 16A cooperating with a mobile device.

### DETAILED DESCRIPTION OF THE INVENTION

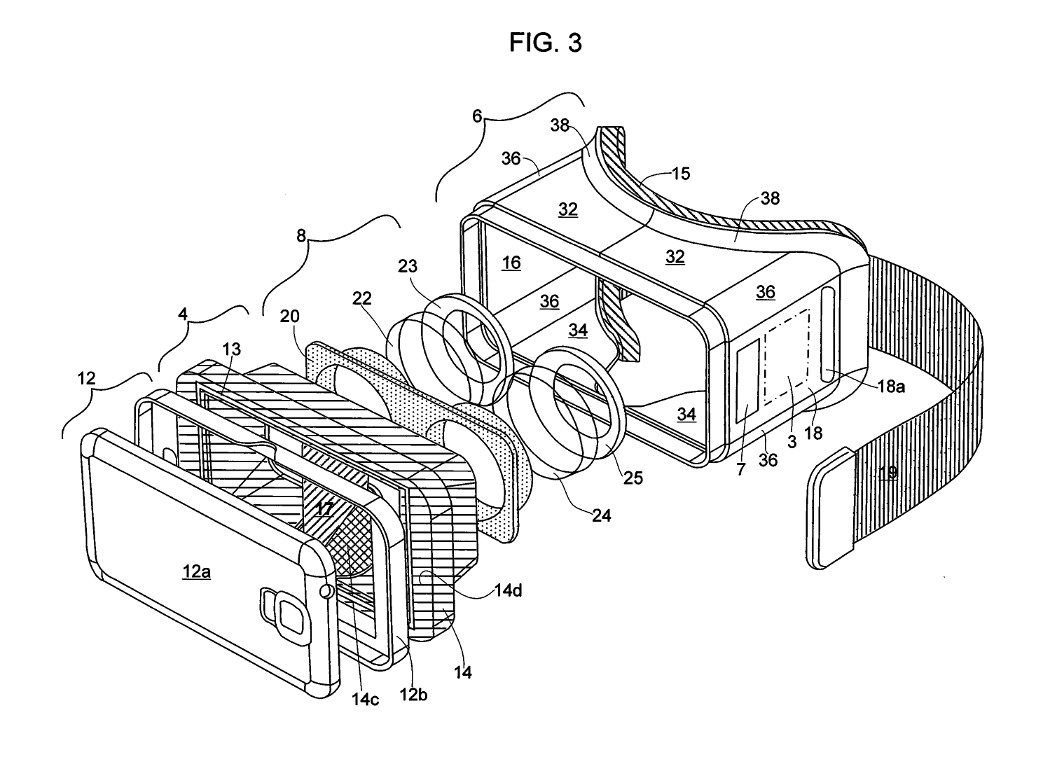

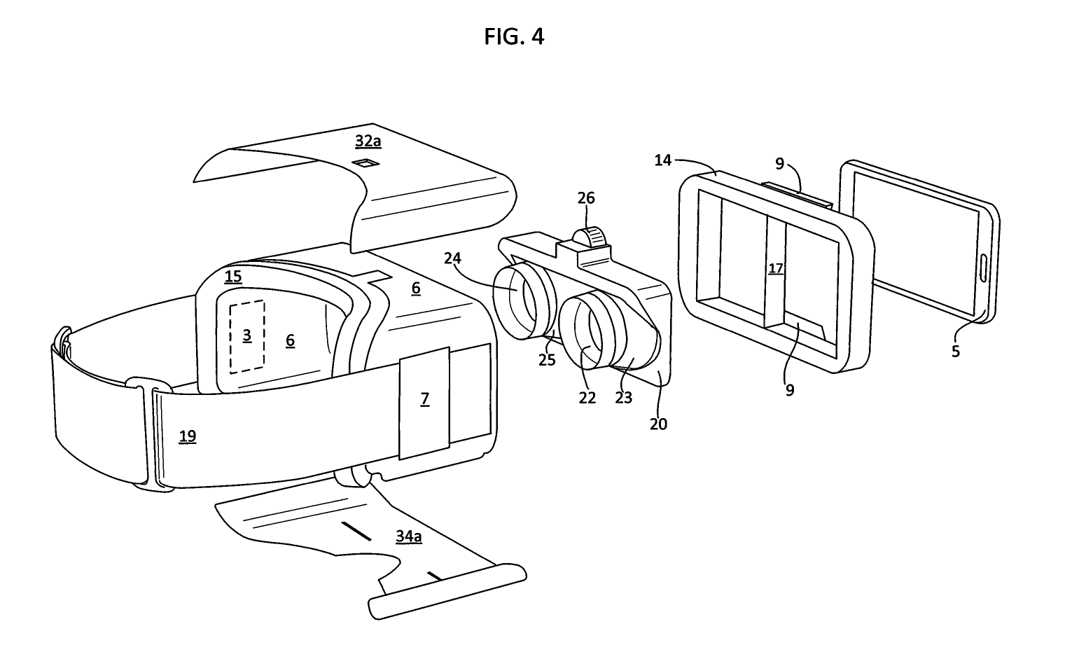

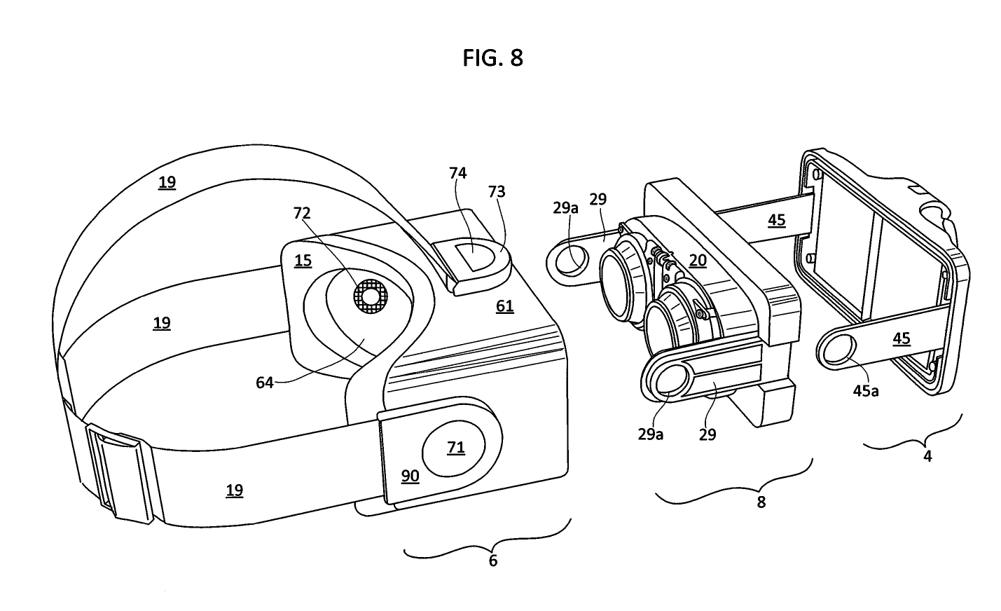

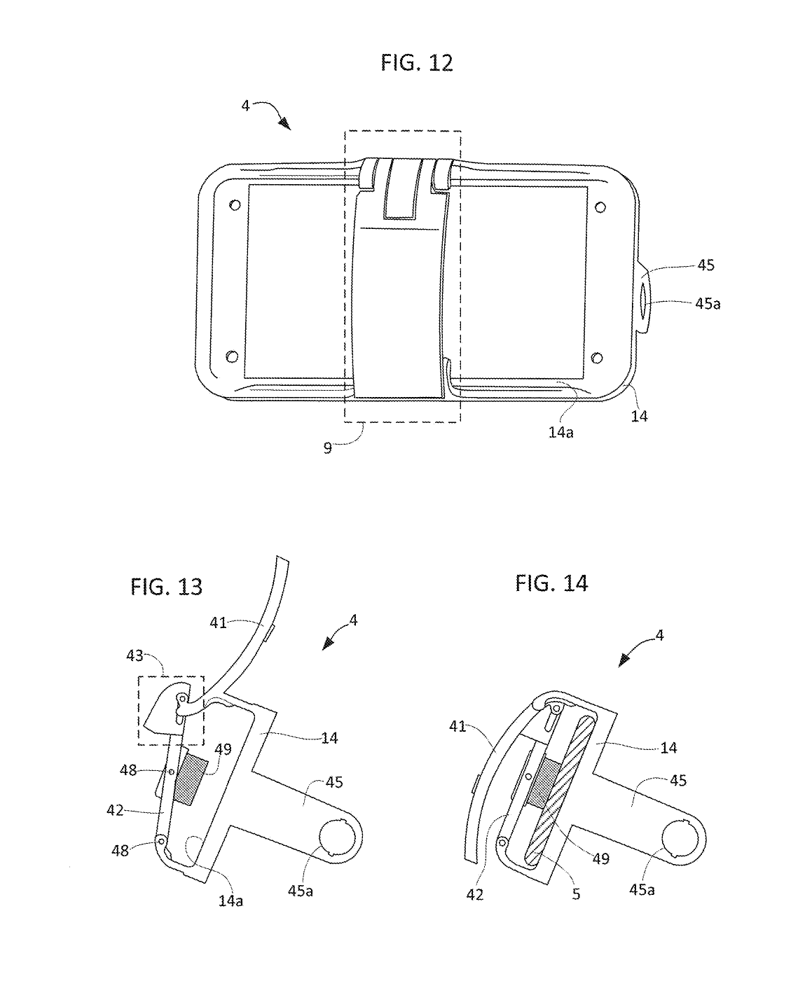

The present invention comprises a modular and customizable virtual reality (VR) headset system 10 that comprises one or more modular segments. As shown in FIGS. 1, 3-5, and 8-9 the modular segments preferably include a headset 11 with a frame assembly comprising a device module 4 and a support module 6, a lens module 8, a comfort module 15, and a strap 19. Additionally, as shown in FIGS. 1 and 3, the modular segments may also include a dedicated mobile device case 12. Device module 4 comprises a base 14, an optional seal 13, and a receptacle or dock 14a defined by or attached to base 14 with optional locks 9 for accommodating the mobile device case 12 or a mobile device 5 directly. Lens module 8 comprises a lens plate 20, a first lens 22, a second lens 24, a first lens cup 23, a second lens cup 25, an optional first lens modifier 27, an optional second lens modifier 28, and a lens adjuster 26. Support module 6 comprises one or more of a first side wall 16, second side wall 18, upper wall 32, lower wall 34, corners 36, edges 38, and covers 32a and 34a. Alternatively, support module 6 comprises an outer wall or shell 61 and an inner wall or shell 64 that attach together and cooperate with each other to form a substantially continuous walled structure. In order to facilitate customization, specific uses, and upgrades, the modular segments cooperate and are secured together with the use of screws, snaps, latches, tension devices, clasps, quarter turns, twist locks, push screws, hook & loop connectors, tongue and groove connectors, and other methods of removably securing components together as is well known to those skilled in the art. Preferably, the components are removably secured such that they do not easily detach when in use. More preferably, the components are removably secured together with simple locking mechanisms or in such a manner that a tool must be used to facilitate detachment. For example, as shown in FIGS. 8-15, several modules attach with nesting extensions 29, 45, 62, 65, and 90 and a plug, key, or insert 72 that extends through holes defined by the extensions.

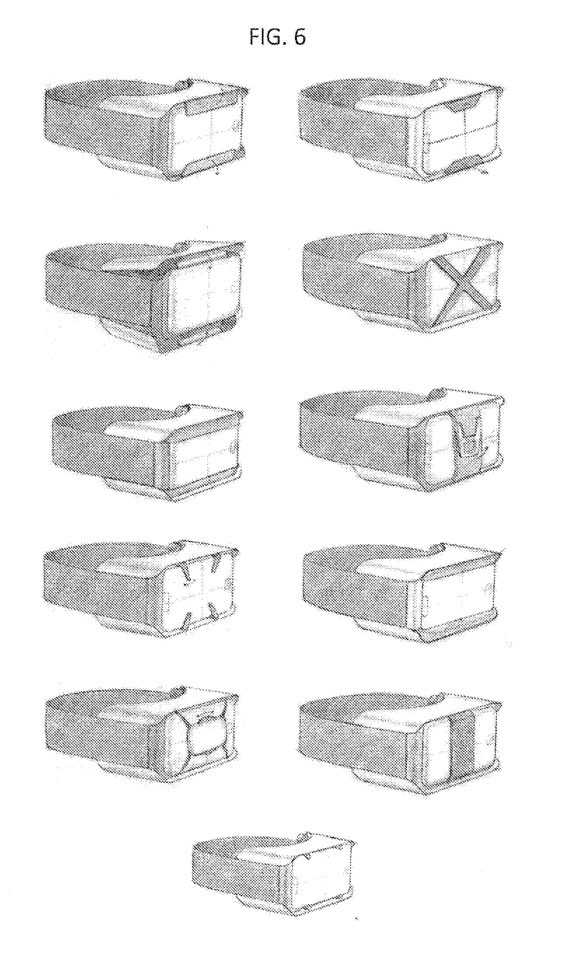

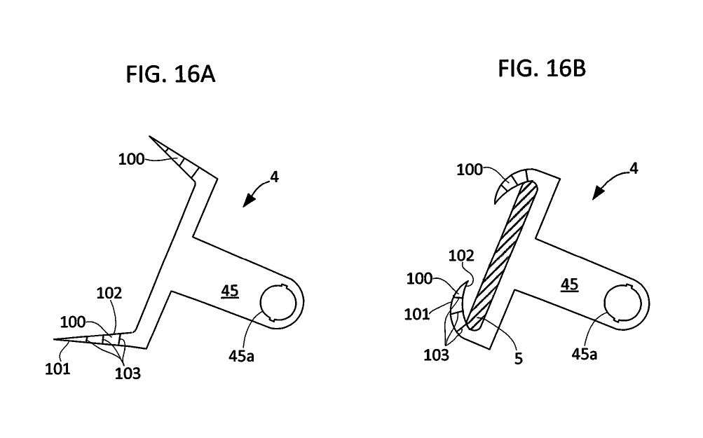

Base 14 of device module 4 is an assembly, frame, or rack with an integral or attached receptacle or dock 14a for preferably cooperating with or holding the mobile device 5 directly or alternatively for cooperating with or holding the dedicated mobile device case 12. Dock 14a can be a receptacle, an opening, a surface, one or more fasteners, or any other type of structure capable of temporarily holding two components together or positioning two components side-by-side. If using dedicated mobile device case 12, preferably the mobile device is securely positioned within case 12 such that the VR headset system cooperates with the mobile device 5 and such that the mobile device's display is viewable to the user when wearing and using the VR headset and system. The mobile device 5 or case 12 can slide into the dock 14a formed by base 14 through an opening on one edge or side of base 14. Alternatively, the mobile device 5 or case 12 can be snapped into, pressed into, set into, or dropped into the dock 14a at an opening on one of the large sides of base 14. Also alternatively, the mobile device 5 or case 12 can be placed, set, or positioned against dock 14a. The mobile device 5 or case 12 preferably is secured in place with a lock 9. Lock 9 can be, for example, a door, slide, clamps, clasps, magnets, cooperating hook and loop fasteners, cooperating tongue and groove fasteners, a pull tension-type latch, opposing or surrounding fin ray extensions, or other physical locking mechanism as is known in the art. FIG. 6 illustrates examples of locking mechanisms suitable for securing a mobile device 5 or case 12 to base 14. FIGS. 8-14 illustrate a preferred lock 9 comprising a pull tension-type latch having a first latch arm 41 pivotally attached with a connector 48 to base 14 near its perimeter and a second latch arm 42 pivotally attached with a connector 48 to base 14 near its perimeter and on an opposite edge from where second latch arm 42 attaches to base 14. Second latch arm 42 further includes a spacer 49 pivotally attached with a connector 48 to latch arm 42 near its longitudinal center. Spacer 49 is preferably comprises resilient material so that it can deform and apply gentle pressure against a mobile device 5 docked in the dock 14a of base 14, as shown in FIG. 14. First arm 41 further pivotally attaches with a hinge mechanism 43 to second arm 42, as shown in FIGS. 13 and 14. The pull-tension type latch is released by pulling first arm 41 up and away from second arm 42. The pull-tension type latch is engaged by pushing first arm 42 down toward and adjacent to second arm 42. An alternatively lock 9 is illustrated in FIGS. 16A and 16B and comprises two or more fin ray extensions 100 that open and close when pressure from the mobile device 5 is applied to the inner flank 101. Each fin ray extension 100 comprises pliable inner and outer flanks 101 and 102 that are joined at their tips and form an acute angle. The two flanks are connected by a plurality of ribs 103 which hold the struts 101 and 102 apart and allow elastic movement. When one flank 101 is subjected to pressure, the geometrical structure automatically bends in the direction opposed to the force applied.

Mobile devices include any personal electronic device or any mobile or handheld device that has a screen, display, or other optical or optometrical component including but not limited to mobile phones, cellular phones, smartphones, tablets, computers, dedicated displays, navigation devices, cameras, e-readers, personal digital assistants, and optical or optometrical instruments. Mobile devices displays including mobile dedicated displays can be any type of display including but not limited to light-emitting diode displays, electroluminescent displays, electronic paper or E ink displays, plasma displays, liquid crystal displays, high performance addressing displays, thin-film transistor displays, transparent displays, organic light-emitting diode displays, surface-conduction electron-emitter displays, interferometric modulator displays, carbon nanotube displays, quantum dot displays, metamaterial displays, swept-volume displays, varifocal mirror displays, emissive volume displays, laser displays, holographic displays, light filed displays, or any other type of output device that is capable of providing information in a visual form. Preferably, in addition to having a screen or display, the mobile device comprises an operating system, can run various types of application software, and is equipped with communication components. Optionally and preferably, especially for a mobile device that is a dedicated display, the mobile device further comprises a high-definition multimedia interface (HDMI) port, a universal serial device (USB) port, or other port or connection means to facilitate direct or wireless connection with a computing device or larger display device such as a television. Alternatively, mobile device can be an optical or optometrical instrument useful for configuring the headset for a particular user. For example, mobile device can be a pupillometer that measures pupillary distance or pupil response and provides guidance for making adjustments to the headset components or for automatically adjusting the headset components.

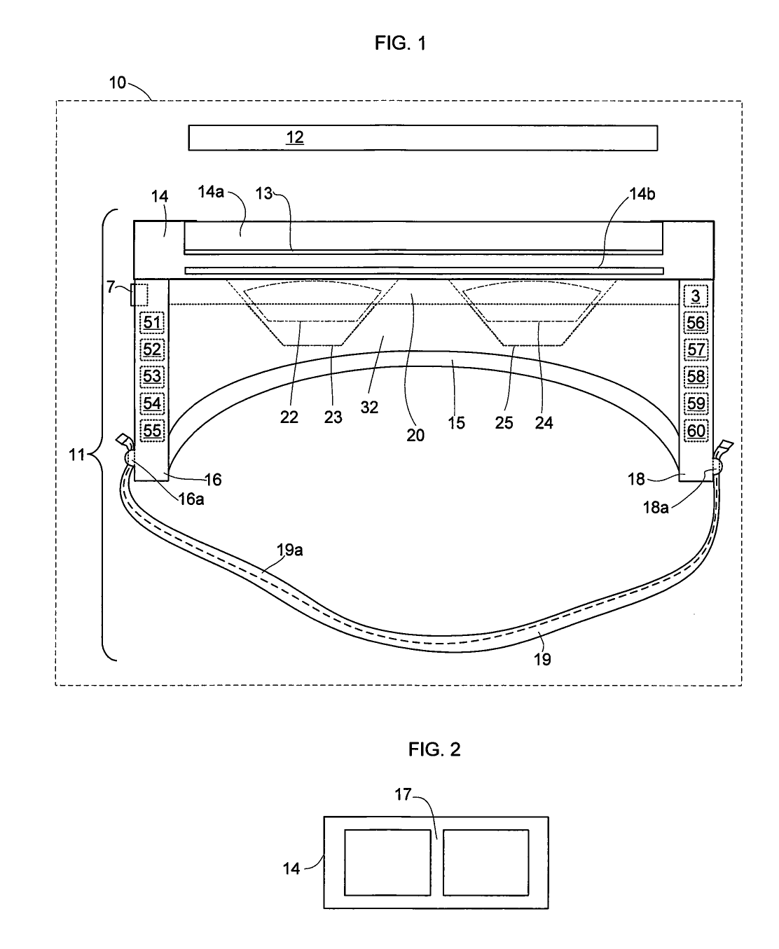

Optional seal 13 of device module 4 is positioned to provide a tight and secure fit between the display side of the mobile device 5 and base 14 or between the display side of case 12 and base 14. Seal 13 can be removable and customizable or it can be permanently affixed to base 14. Additionally, seal 13 can be narrow as shown in FIG. 3 or it can cover a larger or all of the front surface 14d of base 14. Base 14 and seal 13 can each or both optionally and preferably comprises a divider 17 located at its approximate midpoint such that it equally divides the display space on the mobile display with which it cooperates as shown in FIGS. 2-5 and 8-10. Divider 17 is located between the user's eyes when the user wears the VR headset 10 so that each eye sees a different image. Divider 17 can be removable or customizable or it can be affixed to base 14. Base 14 also preferably covers, on the screen or display side of the mobile device, all of the side except for the mobile device display.

Base 14 optionally can include mirrors (not shown) for further enhancing the user's view of the display on the mobile device with which it cooperates. Base 14 also optionally includes a nose piece 14c for providing a comfortable fit for the user. Nose piece 14c can be integrally formed with base 14 or a separate component attached to base 14. Preferably, nose piece 14c is integral with base 14, formed of a substantially solid surface, and contoured to accommodate a user's nose. Optionally, nose piece 14c is easily removable and replaceable and is available in a variety of sizes and colors to accommodate a user's features and preferences.

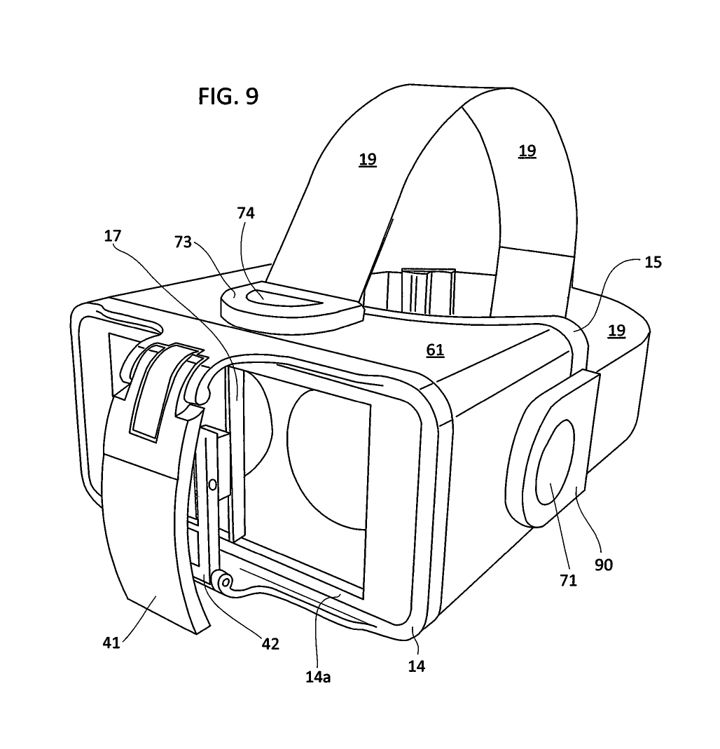

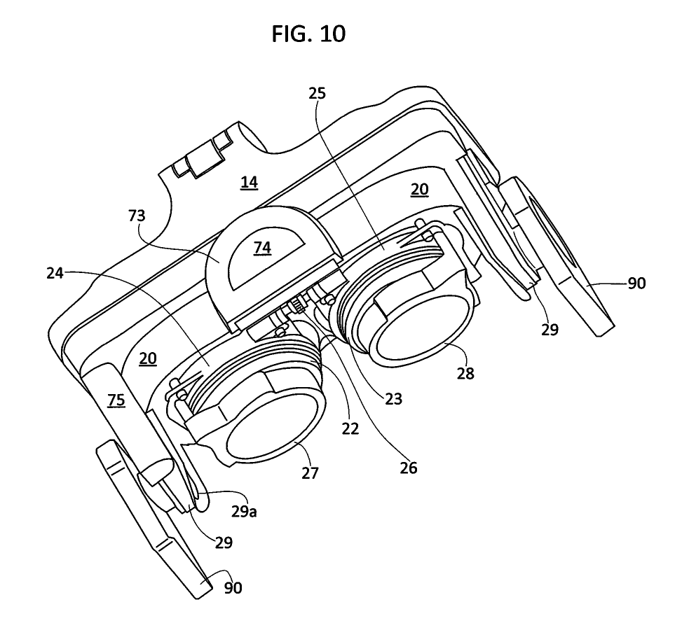

Additional features can be incorporated into base 14 to accommodate accessories. For example, base 14 can also define a slot 14b for inserting additional filters or screens or mirrors to alter the user's viewing experience or such options can be permanently secured in base 14. Openings, access ports, and buttons can be located at various locations around base 14 to accommodate physical buttons, microphones, headphones, USB ports, communication components, computer and computing components, and other components that are either present on the mobile device or are part of additional headset components such as additional displays, cameras, and audio devices. Base 14 also optionally includes an easily accessible housing location for optional communication components such as near field communication (NFC) components or other control and processing components 5. FIG. 10 illustrates a housing 75 that can be attached to base 14 to house such components.

Base 14 preferably comprises a substantially rigid or semi-rigid material capable of securing the weight of the mobile device and/or case 12 with which it cooperates. Base 14 can be a solid color or can incorporate designs or patterns, and preferably base 14 is available in a variety of colors, designs, and patterns to accommodate the specific tastes of the user. For example, if the user prefers the color pink, the user can select a pink base 14. Alternatively, if the user prefers green camouflage, the user can select a green camouflage base 14.

Mobile device case 12 preferably comprises a sleek design that cooperates with base 14 and can be comfortably carried by the user when not being used with the VR headset 11. Case 12 is configured such that it does not need to be removed from the user's mobile device to use the mobile device with headset 11 and such that it directly attached to or fits in the dock of base 14. Case 12 can be made from a variety of materials including but not limited to plastic, carbon fiber, and rubber. Case 12 can be a solid color or it can incorporate designs, patterns, or themes. For example, case 12 can be a solid orange color or it could have an image or feature of a popular video game displayed on it. Case 12 preferably includes ports, buttons, or openings to accommodate the camera, buttons, charging ports, and other features of the mobile device. Case 12 preferably is sized and configured such that when positioned in or cooperating with base 14 no light will pass into the field of view of the viewer when using the VR headset system 10. Case 12 can be one component as shown in FIG. 1 or multiple components as the case components 12a and 12b shown in FIG. 3.

Support module 6 of headset 11 is the frame or support into which a user places his head and face. In one embodiment, support module 6 comprises at least one or more of the following components: first wall 16, second wall 18, upper wall 32, lower wall 34, corners 36, edges 38, and covers 32a and 34a. As shown in FIG. 3, first and second side walls attach to optional upper wall 32 and lower wall 34 at corners 36 to create a substantially continuous surface or wall. First and second side walls and upper and lower walls can be four separate components directly connected or connected with corners 36. Alternatively, the walls 16, 18, 32, and 24 and corners 36 can be integrally formed as one component as shown in FIG. 4, and can further include covers such as first cover 32a and second cover 34a shown in FIG. 4. Where the walls are separate components, first and second side walls 16 and 18 and upper and lower walls 32 and 34 are preferably changeable and removably attach to base 14. First and second side walls 16 and 18, upper and lower walls 32 and 34, and optional corners 36 can be attached to base 14 with snaps, hook & loop connectors, tongue and groove connectors, magnets, latches, adhesive, screws, or any other method of temporarily and securely two components together as is well known in the art. One or more edges 38 can optionally attach to walls 16, 18, 32 and 34 and corners 36 at the opposite end from base 14 as shown in FIG. 3. Edges 38 allow a user to further customize his headset 11. Side walls 16 and 18, upper and lower walls 32 and 34, corners 36, and edges 38 are preferably configured to block light from entering headset 11 when in use. First and second covers 32a and 34a attach to one or more of walls 16, 18, 32 and 34 or to corners 36 or edges 38 with fasteners or by snapping into place with a pressure fit. Covers 32a and 34a preferably define openings (not labelled) where necessary to allow a user to access controls or ports or to allow access to other components of the headset.

Lower wall 34 of support module 6 optionally includes a nose piece or defines a cutout to accommodate a nose piece as shown in FIG. 3, and one or more walls preferably include physical features for accommodating a cooperating strap 11. For example, side walls 16 and 18 may each include a slot 16a and 18a respectively, through which a strap 19 can be attached or snaps to which a strap can attach. Additionally, slots 16a and 18a can include pushbutton locks or lace locks to facilitate adjustability, or they may be configured as multiple slots that allow the strap to be adjusted or held stationary depending on how the strap is looped through the multiple slots. Other methods of facilitating strap adjustability can be substituted without changing the scope of the present invention.

Additionally, side walls 16 and 18, upper and lower walls 32 and 34, corners 36, edges 38, and covers 32a and 34a are available in a variety of sizes, shapes, and colors to allow the user to customize the fit, the use, and the look of the headset. As with base 14, first and second side walls 16 and 18, upper and lower walls 32 and 34, corners 36, edges 38, and covers 32a and 34a preferably comprise substantially rigid or semi-rigid materials capable of securing the weight of the base 14 and mobile device and/or case 12 with which it cooperates. Walls 16, 18, 32, and 34, corners 36, edges 38, and covers 32a and 34a can be a solid color or can incorporate designs or patterns, and preferably are available in a variety of colors, designs, and patterns to accommodate the specific tastes of the user.

An alternate and preferred configuration of support module 6 is shown in FIGS. 8-10 and 11A-11B. As shown, support module 6 comprises an outer wall 61 and an inner wall 64. Outer wall 61 comprises a substantially continuous structure or shell that defines upper and lower walls and opposing side walls. Additionally, outer wall 61 comprises a first surface 63 that can accept additional modules such as a comfort module 15. The side walls of outer wall 61 form side extensions 62 and define generally opposing openings or holes 62a through which attachment devices such as a plug, key, or insert 72 can be inserted. Inner wall 62 comprises a substantially continuous structure or shell that defines an upper wall, a lower wall, and opposing side walls. Additionally inner wall 64 comprises a first surface 66 that cooperates with and optionally physically attaches to device module 4 or lens module 8. The side walls of inner wall 64 define side extensions 65 that are sized and shaped to cooperate with extensions on the device module 4 and the lens module 8. Preferably, side extensions 65 are configured as indentations in the substantially continuous wall 64. The side extensions 65 of inner wall 64 further define generally opposing openings or holes 65a through which attachment devices such as a plug, key, or insert 72 can be inserted. Together, complementary inner wall side extension 65 and outer wall side extension 62 cooperate to form a support module extension, and there can be multiple support module extensions located at various locations of the support module. Preferably inner wall 64 snugly fits inside of outer wall 64, and when inner wall 64 is positioned within outer wall 61, holes 65a and 62a are configured so that they align. Inner wall 64 can be retained within outer wall 61 either by pressure or a snug fit or it can be attached with screws, adhesive, magnets, or other types of fasteners.

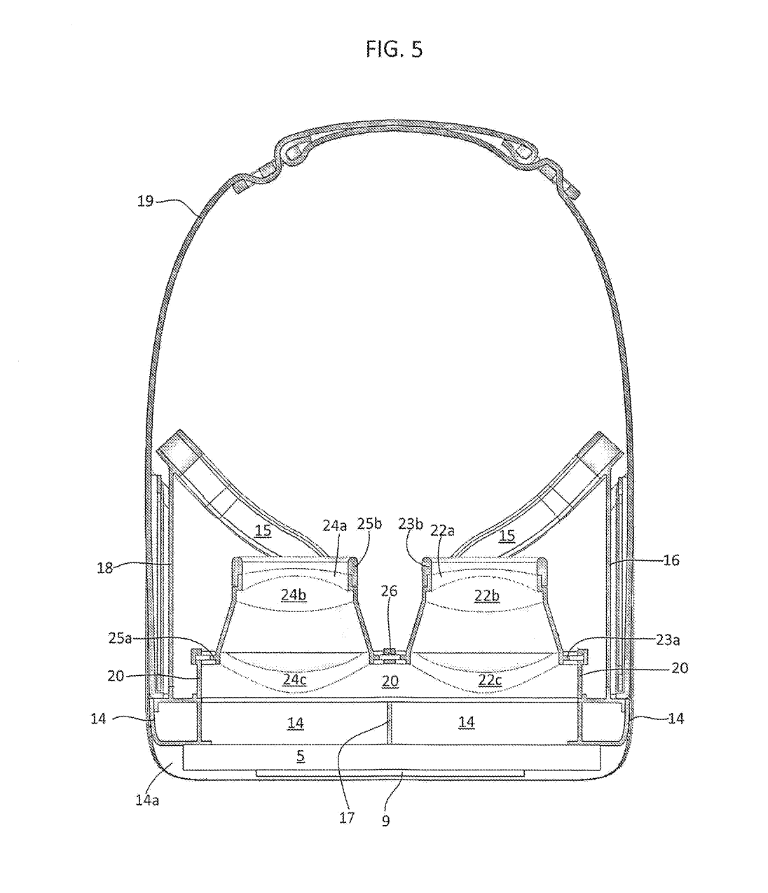

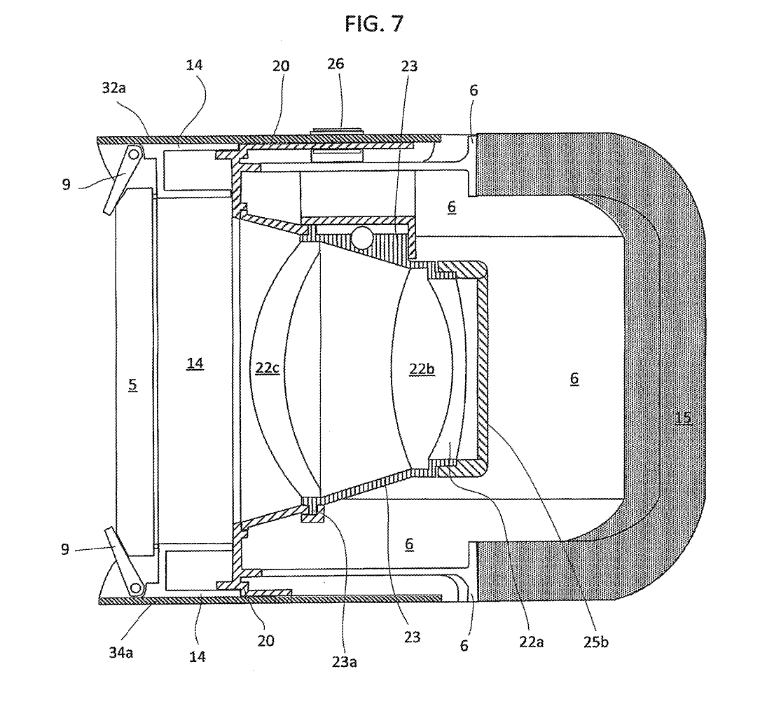

Lens module 8 preferably comprises a lens plate 20, lens cups 23 and 25, lenses 22 and 24, optional first lens modifier 27, optional second lens modifier 28, and at least one lens adjuster 26. Lens plate 20 is a support or plate that defines two openings (not labeled). Each of the openings defined by plate 20 accommodates lens cups 23 and 25. Lens cups 23 and 25 snap into lens plate 20 with detents, pins, extensions, or flanges 23a and 25a as shown in FIGS. 5 and 7, for example, or push screw into place such that lens cups 23 and 25 can be easily removed and changed as needed. Alternatively, other methods of fastening two objects together can be used as is known in the art. The openings in lens plate 20 or the lens cups 23 and 25 can optionally be adjusted so that the openings are closer together or further apart. Additionally, lens cups 23 and 25 can be moved, or lens plate 20 further facilitates adjusting the openings, such that they can be moved higher or lower with respect to a user's eyes or closer or further from a user's eyes. Moreover, each lens cup can be adjusted independently of the other lens cup. Lens adjuster 26 facilitates adjustment of the lens cups or openings in the lens plate. As shown in the Figures, lens adjuster 26 is an adjuster knob or screw that when rotated causes the lens cups and openings to move in a predetermined direction. Only one lens adjuster 26 is shown in the Figures but several can be included to control movement of the lenses, lens cups, or openings as desired and as will be understood by someone skilled in the art. Additionally, lens plate 20 can be configured to position lenses 22 and 24 at a specific distance from dock 14a and the mobile device display. For example, a flange can be located around the circumference of lens plate 20 to control depth. Alternatively, fasteners for securing lens module 8 to support module 6 can attach at different locations along support module 6. Lens plate 20 can be available in a variety of shapes in order to accommodate different user's requirements as to what distance the user desires between lenses 22 and 24 and the mobile device display.

Lens module 8 and lens plate 20 removably secure to either device module 4 or support module 6 or both. Lens module 8 and lens plate 20 can be removably secured to support module 6 and/or device module 4 with snaps, hook & loop closure, tongue and groove fasteners, magnets, latches, adhesive, screws, or any other method of temporarily and securely two components together as is well known in the art. For example, lens module 8 and lens plate 20 can be pressure fit into base 14 of device module 4 or attached to the first and second side walls 16 and 18 of support module 6 with interlocking tongues and grooves. Lens module 8 and lens plate 20 preferably comprises substantially rigid or semi-rigid materials capable of securing the weight of two lenses and lens cups.

FIGS. 8-15 illustrate a preferred method of removably securing lens module 8 to device module 4 and support module 6 wherein modules 4, 6, and 8 comprise extensions defining openings and holes. Support module 6 comprises an extension or complementary extensions such side extension 62 and extension or extension indent 65 that can receive the extensions of modules 4 and 8. Additionally, the extensions of modules 4, 6, and 8 nest together. When nested, the holes of the extensions and extension indents substantially align to receive a plug, key, or insert 72. When the plug 72 is placed through the aligned holes, the modules are securely attached together. The extensions of the lens module 8 are shown in the Figures as lens module extensions 29. The extensions of the device module 4 are shown in the figures as device module extensions 45. The extensions of the support module 6 are shown in the Figures as wall extension 62 and wall extension 65. Preferably, support module extension or complementary extensions receive the device module extensions such that the device module extension is nested in the support module extension or complementary extensions, and device module extensions receive the lens module extensions such that the lens module extensions is nested in the device module extension.

First and second lens cups 23 and 25 are shaped and configured to house first and second lenses 22 and 24. Preferably, two separate lenses and corresponding lens cups are present, however the same features apply if only one lens and lens cup is required without altering the scope of the invention. Generally, lenses 22 and 24 comprise acrylic, glass, or polymers and are preferably removably secured, or optionally permanently secured, within lens cups 23 and 25. Lenses 22 and 24 also may comprise aspheric lenses, achromatic lenses, plano-convex (PCX) lenses, double-convex (DCX) lenses, hybrid fused lenses, lenses made with metamaterials, lenses made with digital metamaterials, super lenses, flat lenses, lenses with a negative refractive index, or lenses with an air gap or space between its elements. Lenses 22 and 24 can be a single lens or can be a cooperating series of lenses. For example, preferably, lenses 22 and 24 comprises a triple lens series as shown in FIG. 7, each of which comprises a proximal lens 22a or 24a, a middle lens 22b or 24b, and a distal lens 22c or 24c. More preferably, first proximal lenses 22a and 24a are glass, middle lenses 22b or 24b are glass, and distal lenses 22c or 24c are plastic. Additionally, an air gap is defined between distal lenses 22c and 24c and middle lenses 22b and 24b. Lenses 22 and 24 and lens cups 23 and 25 are oriented with respect to the lens plate 20 and base 14 as shown in FIG. 1. Further, lens cups preferably comprise a truncated conical shape or funnel shape as shown in FIG. 1. The preferred shape of lens cups 23 and 25 limits the view of the user when viewing the display on the mobile device so that the user does not see the entire mobile device display. Lens cups 23 and 25 preferably twist and lock into the lens plate 20 or can be pressure fit or snapped into place. Alternatively, lens cups 23 and 25 can be otherwise removably secured to lens plate 20 as will be known to someone skilled in the art such that they remain rigidly and securely attached an oriented with respect to lens plate 20. Lens cups 23 and 25 may additional comprise integral or attached eye cups 23b and 25b that are positioned at the end of lens cups 23 and 25 near where a user rests his eyes as shown in FIGS. 5 and 7 to provide a comfortable fit and further to adjust to the contours of the user's face near his eyes. Eye cups 23b and 25b preferably comprise plastic, rubber, or other rigid or resilient material.

Optional lens modifiers 27 and 28 can be any type of device useful for modifying a lens or a user's view through a lens such as filters, shutters, prescription glass or lens, eye tracking devices, or transparent displays. Lens modifiers 27 and 28 preferably can be added to or removed from the headset and lens module as needed by the user. Lens modifiers 27 and 28 can be separate physical structures that attach directly to each lens as shown in FIGS. 8-10 and such that each lens modifier is positioned between a user's eye and the lens when in use. Alternatively, lens modifiers 27 and 28 can be positioned between a first and second lens component of a multi-part lens for each eye. Lens modifiers 27 and 28 can snap, screw, clip, or adhere to adjacent components and optionally connect to a battery or power source positioned on or in headset 11 as needed.

While it is desired that lens plate 20, lens cups 23 and 25, lenses 22 and 24, and optional lens modifiers 27 and 28 be modular and upgradeable, a variety of lens plates 20 can be provided with permanently secured lens cups, lenses and/or lens modifiers without altering the scope and purpose of the present invention. Additionally, lens plate 20 and lens cups 23 and 25 can be one component or can be an integral support or framework for lenses 22 and 24. For example, lens plate 20 can be a frame in which lens cups 23 and 25 are positioned so that they can translate in various directions including horizontally and vertically.

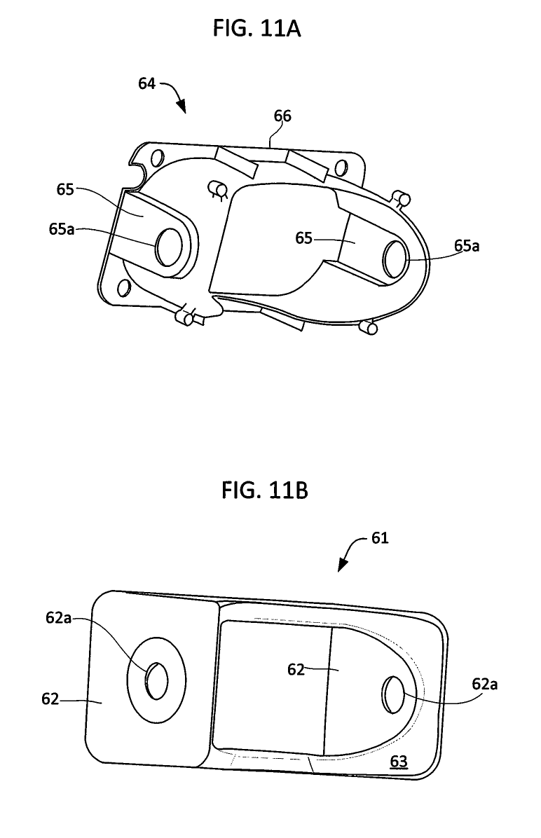

Comfort module 15 is optional and removably attaches to and between first and second side walls 16 and 18 as shown in FIG. 1 or along the edge of support module 6 as shown in FIGS. 3-5 and 7-9. It is positioned such that it fits between the user's face and support module 6 or lens module 8 when the user wears headset 11 to make the user more comfortable and to improve the fit of the headset. In one embodiment, comfort module 15 attaches directly to surface 63 of outer wall 61 of support module 6 as shown in FIG. 11B. Comfort module 15 comprises foam or other resilient material that allows it to mold to the user's face when in use. Other resilient materials include but are not limited to microfiber, hypoallergenic materials, memory foam, and cool memory foam. Comfort module 15 can be removably secured to support module 6 with snaps, hook & loop closure, latches, adhesive, screws, or any other method of temporarily and securely two components together as is well known in the art. Alternatively, it can be permanently affixed or adhered to support module 6 if desired. Comfort module 15 can also be available in a variety of colors and patterns to allow the user to customize his headset as desired.

Strap 19 comprises adjustable strap material for securing the headset to the user's head by extending from first side wall 16 around the back of the user's head to second side wall 18 as shown in FIG. 1 or for extending between opposite sides of support module 6. Strap material is well known in the art. Strap 19 also is preferably adjustable and available in a variety of colors and patterns to allow the user to customize his headset as desired. Strap 19 optionally comprises a channel 19a for accommodating wires for headset 11 components or for independent components. For example, strap 19 may accommodate headphone components for the user's convenience and to enhance the VR experience when using the VR headset system 10. Alternatively, strap 19 can house audio or other components including headphone wires, battery packs, or wires for connecting to other components.

Strap 19 preferably removably secures to side walls 16 and 18 as shown in FIGS. 1 and 3-5 or at the sides of outer wall 61 and optionally the top of outer wall 61 as shown in FIGS. 8-10. Also, as shown in FIGS. 8-10, strap 19 can also include a section that extends up and over a user's head. For example, strap 19 can be looped through slots in side walls 16 and 18 and optionally to upper wall 32 or attach with cooperating snaps to side walls 16 and 18 and optionally upper wall 32. In a preferred embodiment, as shown in FIGS. 8-15, strap 19 attaches to the sides and upper surface of outer wall 61 with locking connectors 90 that are configured to cooperate with nesting extensions of the device, support, and lens modules and plug 72. In some embodiments, a modified locking connector 73 can be used that further includes a power button 74 or other input device as shown in FIGS. 8-10. Modified locking connector 73 can be identical to locking connector 90 or it can be fixedly attached to the support module 6, device module 4, or lens module 8.

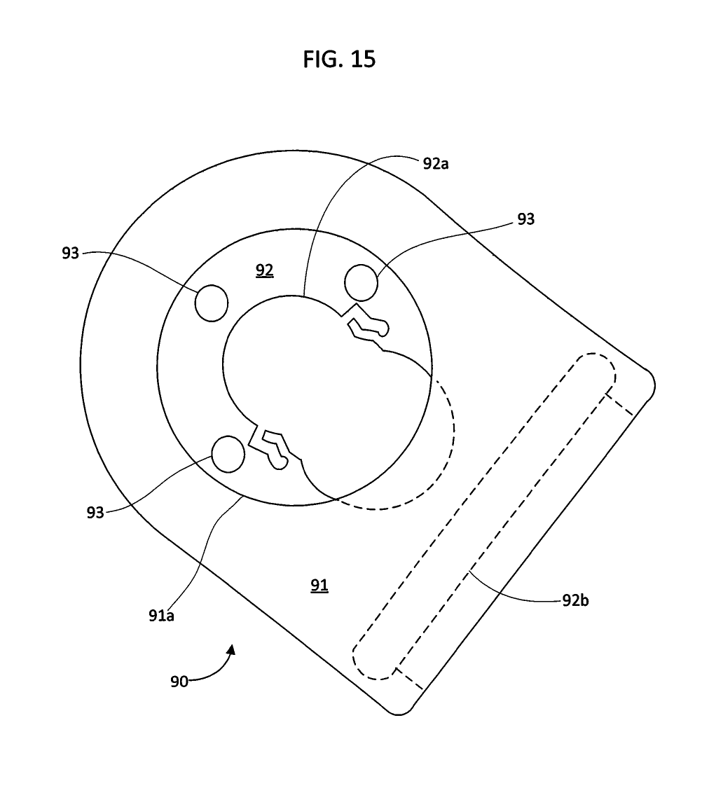

FIG. 15 illustrates a preferred connector 90 having an upper surface 91 and a cooperating lower surface 92. The perimeters of upper surface 91 and lower surface 92 align and define a space between them. Upper surface 91 defines an opening 91a for receiving a removable cover 71. Removable cover 71 snaps into receivers 93 on lower surface 92. Lower surface 92 defines a first opening 92a shaped like a beetle or multiple adjacent circular holes with notches and a second opening shaped to receive an end of strap 19. First opening 92a receives plug 72 and can be adjusted while plug 72 is positioned in it such that connector 90 can slide and lock into place after plug 72 is inserted. The preferred design of connector 90 allows a user to easily take apart the modules by removing cover 71, sliding connector 90 to allow access to plug 72, and then removing plug 72. Moreover, when a user wants to assemble the module device, the user simply nests device and lens module extensions 45 and 29 in complementary support module extensions 65 and 62 so that the holes 45a, 29a, 65a, and 62a all align. The user then positions connector 90 over the aligned holes, inserts plug 72, slides connector 90 until it locks in place, and then optionally places cover 71 in opening 91a, and optionally secures it in place by placing snap extensions (not shown) into receivers 93.

VR headset 11 also preferably includes control and processing components 3. Control and processing components 3 preferably include a processor, memory, and wireless or wired communication components as is well known in the art. Wireless communications components include NFC components and longer range communications components to facilitate communication with the user's mobile device and to facilitate communication with software and content located remotely or accessible only via the Internet. Wired communication components include components configured to interact with a port or connection on the mobile device so that there is a direct wired connection between the mobile device and the control and processing components in the headset. Additionally, software can be stored on the memory and executable by the processor to permit the user to communicate and interact with his mobile device while using the headset. Additional software can be stored on the memory and executable by the processor to permit only authorized access by the user, to convert the display of the mobile device into a stereoscopic display, to view two-dimensional content as three-dimensional content, and to operate lens modifiers 27 and 28 if needed. Further, mobile devices may alternatively store software as either content added after production of the mobile device or as part of the protected layer of firmware for the mobile device that can be remotely accessed by the control and processing components of the VR headset 11 through the headset's NFC or other wireless communication methods or by direct connection or electrical communication between the mobile device and headset 11 such as with a USB connection.

VR headset 11 is modular and customizable to satisfy the user's personal aesthetic preferences and also to optimize the VR experience. To optimize the VR experience, one or more of the walls 16, 18, 32, 34, 61 and/or 64, lens plate 20, lens cups 23 and 25, lenses 22 and 24, comfort module 15, and strap 19 are all selected and configured according to several factors specific to the user's head shape and size, the user's mobile device, and the type of programming to be enjoyed with the headset 11. In particular, the walls 16, 18, 32, 34, 61 and/or 64 and lens module 8 components will be optimized according to the mobile device screen size, the mobile device screen resolution, the mobile device DPI, and the type of programming being accessed, such as a video or an interactive game. For example, higher resolution mobile devices allow for the lenses to be physically closer to the mobile device screen, which then makes the experience more immersive and also requires a lens plate 20 and at least side walls 16 and 18 to be selected such that the lenses 22 and 24 are closer to the mobile device display. Conversely, lower resolution mobile devices are better enjoyed with lenses that are further away from the mobile device display. Accordingly, the lens plate 20 and at least side walls 16 and 18 should be selected such that the lenses 22 and 24 are the appropriate distance from the mobile device display. The lenses and other components may also be selected based on the particular user's preference and vision.

Additional features and components can also be included with the VR headset system 10 either as permanent features and components or as modular and removable features and components. For example, VR headset system 10 can further include a microphone 51, headphones 52, or both that physically attach to or are housed within headset 11 and cooperate and communicate with headset 11, the attached mobile device, or both. Microphone 51 and headphones 52 are preferably attached to or housed within device module 4 or support module 6.

VR headset 11 may further include motion detection sensors 53, head tracking technology 54 and/or eye movement tracking technology 55 such as accelerometers, gyroscopes, integrated depth sensors, computer vision technology, lasers, light detection and ranging (LiDAR) technology, and wireless network (WiFi) triangulation technology. Hand movement sensors or trackers or other body movement sensors or tracker may also communicate electronically or wirelessly with cooperative technology 56 included in headset 11, the attached mobile device, or both. The motion sensors and tracking technology may also communicate with other technology outside of the headset 11 and attached mobile device. Sensors 53, head tracking technology 54, and eye movement tracking technology are preferably attached to or housed within one or more of device module 4, support module 6, or lens module 8. Alternatively, they can be housed separately from headset 11 and in electrical or wireless communication with components of headset 11. Additionally, VR headset 11 may have impute or ports for attaching third party accelerometers or motion detection or other sensors that cooperate with headset 11.

VR headset 11 optionally may comprise a camera 57 and additional displays 58 such as an integrated, permanently attached, or removably attached external display that displays to non-users the content or a simplified version of the content being experienced by the user, which may be particularly useful as a parental control feature. Additionally or alternatively, an integral, permanently attached, or removably attached a display may be included within the view of the user so he can view additional programming or the output of one or more attached or wirelessly connected cameras 57. Cameras 57 can be a video camera for either or both recording what the wearer is experiencing or what is actually occurring in his surroundings. Additionally, camera 57 may physically or wirelessly communicate and cooperate with mobile device 12 and split the content or enhance the existing camera on the attached mobile device. Camera 57 and displays 58 are preferably integral with or attached to or housed within device module 4 or support module 6.

VR headset 11 also optionally and preferably may comprises buttons, toggles, joysticks, touchpads, or other input devices 7 for operating the settings of the headset itself or for making selections in the software being accessed with the headset and by the user. While the input devices are shown in FIG. 3 as being attached to or housed with support module 6, they could also optionally be attached to or housed in device module 4 without altering the scope of the invention. The input devices 7 may also be used to control the typical input devices of the mobile device. For example, if a user was wearing headset 11 and received a call on his mobile device, he could use an input device on headset 11 to answer the call on his mobile device without having to remove the mobile device from headset 11.

VR headset 11 optionally may also include technology that allows for hands free use of the headset 11 and the user's mobile device. Preferably, such technology uses voice recognition components such as a microphone and code or software that is either stored on the memory and executable by the processor of the VR headset 11 or stored remotely and accessed wirelessly to allow hands free use of either or both of the headset and mobile device. Additionally, such technology can comprise Bluetooth® technology, wireless sensor networks, advanced network tools (ANT+), wireless home digital interface technology (WHDI), or other local area wireless technologies such as WiFi. Further, VR headset 11 may optionally include technology that permits access to stored financial information and usernames and passwords to facilitate purchases and game, Website, and application access. Preferably, such technology uses NFC components and code or software that is either stored on the memory and executable by the processor of the VR headset 11 or stored remotely and accessed wirelessly to only allow access to financial information, usernames, and passwords, when the user's mobile device is physically located in or attached to base 14. Also preferably, when the mobile device is removed from base 14, access to financial information, usernames, and passwords is prevented.

Additional features may be included with the VR headset system 10 that provide warnings to user when components are not operating appropriately, when the user's mobile device is not connected properly, or when potential safety issues are present. Such warnings may comprise audible warnings, vibrations, or other warning signals. Additionally, such warnings can comprise proximity sensor or an augmented reality overlay with warnings from the actual camera of the VR headset 11 or of the cooperating mobile device.

VR headset 11 may also include a rechargeable battery 60 preferably housed within device module 4 or support module 6 or as a detachable battery pack that can located on the headset 11 or worn on the user and in electrical communication with headset 11. Additionally, it may include a battery charger for charging the attached mobile device to extend its battery life. VR headset 11 may also further include components to reduce the user's exposure to electromagnetic radiation such as shields, dissipation assemblies, dissipation antennas or the like.

To use the VR headset system 10 of the present invention, for one embodiment, the user preferably selects a case 12 that cooperates with his mobile device 5. For both embodiments, the user also preferably selects his desired components for the headset 10 based on his aesthetic preferences, his desired use, and his mobile device. After selecting the components and assembling and optimizing his headset 11, the user inserts his mobile device 5 or mobile device 5 and case 12 into the dock or receptacle 14a formed by base 14 and optionally locks it in place with lock 9. Once locked in place, with the control and processing components 5 positioned in the headset 11, an application, code, or software stored locally or stored remotely and accessed wirelessly, is activated to place the mobile device in a three-dimensional mode where the mobile device display is split into side by side stereoscopic displays. Additionally or alternatively, headset 11 can access other applications, code, or software stored remotely and accessed wirelessly or stored locally to immediately allow mobile device to operate in a 3D mode. Additionally, if authorization or security protocols are desired that permit access to financial information, usernames, and passwords only when the user's mobile device is present in headset 11, then using software stored locally or stored remotely and accessed wirelessly, the stored information is immediately accessible. While wearing headset 11 with an attached mobile device, the user can then use any features present such as hands-free components, input devices, a microphone, headphones, a video-camera, a heads-up display, or another feature. All features are available until the user removes his mobile device and case 12 from base 14. Once the mobile device and case 12 are removed, headset 11 ceases communication with the mobile device and optionally turns off.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

I claim:

1. A modular virtual reality headset system that can be customized and assembled by the user comprising:
a. a frame assembly comprising two or more cooperating removable and interchangeable components;
b. a dock defined by the frame assembly and configured to receive a mobile device; and
c. a lens module configured to removably attach to the frame assembly, wherein the lens module comprises one or more removable and interchangeable lenses.

2. The modular virtual reality headset system of claim 1 wherein the frame assembly comprises a device module configured to removably attach to a support module and wherein the dock is defined by the device module.

3. The modular virtual reality headset system of claim 2:
a. wherein the device module further comprises a first device module extension and wherein the first device module extension defines an opening;
b. wherein the support module further comprises a first support module extension wherein the first support module extension defines an opening;
c. wherein the lens module further comprises a first lens module extension wherein the first lens module extension defines an opening; and
d. wherein the first device module extension, first support module extension, and first lens module extension nest together when the headset is assembled and the openings in each of the first device module extension, first support module extension, and first lens module extension align when the headset is assembled.

4. The modular virtual reality headset system of claim 3 further comprising a first removable plug configured to cooperate with the first device module extension, first support module extension, and first lens module extension such that it extends through the openings of the first device module extension, first support module extension, and first lens module extension when the headset is assembled.

5. The modular virtual reality headset system of claim 4 further comprising at least one strap removably attached to at least a first strap connector wherein the first strap connector defines an opening configured to cooperate with the first plug and to secure the first plug when the headset is assembled.

6. The modular virtual reality headset system of claim 2 wherein the support module comprises one or more interchangeable walls and wherein the walls removably attach to the device module.

7. The modular virtual reality headset system of claim 6 wherein the interchangeable walls of the support module comprise one or more support module extensions and wherein the device module comprises one or more device module extensions and wherein the device module extensions nest within the support module extensions when the headset is assembled.

8. The modular virtual reality headset system of claim 7 wherein the lens module further comprises one or more lens module extensions and wherein the lens module extensions nest within the device module extensions when the headset is assembled.

9. The modular virtual reality headset system of claim 8 wherein each lens module extension defines an opening, wherein each device module extension defines an opening, wherein each support module extension defines an opening, wherein the openings defined by nesting lens module extensions, device module extensions, and support module extensions substantially align when the headset is assembled and wherein the headset system further comprises one or more plugs that removably secure within the aligned openings.

10. The modular virtual reality headset system of claim 2 further comprising one or more locks for securing the mobile device in the dock of the frame assembly.

11. The modular virtual reality headset system of claim 10 wherein the lock for securing the mobile device in the dock is a pull tension-type latch.

12. The modular virtual reality headset system of claim 1 further comprising control and processing components housed in the frame assembly and one or more input devices housed in the frame assembly and configured to receive input from the user and to cooperate and communicate with the control and processing components.

13. The modular virtual reality headset system of claim 12 further comprising communication components housed in the frame assembly and configured to communicate with at least the mobile device positioned in the dock of the frame assembly.

14. The modular virtual reality headset system of claim 1 wherein each lens comprises a proximal lens, a middle lens positioned adjacent to and optically aligned with the proximal lens, a distal lens positioned near to and optically aligned with the middle lens, and an air gap defined between the middle lens and the distal lens.

15. The modular virtual reality headset system of claim 1 further comprising a case configured to house a mobile device and configured to cooperate with the dock such that the case can be secured to the frame assembly and such that the mobile device remains housed in the case when the case is cooperating with the dock.

16. The virtual reality headset system of claim 1 wherein the lens module comprises a lens plate, a first lens removably secured to the lens plate, a second lens removably secured to the lens plate, and at least one lens adjuster positioned on the lens plate and configured to cooperate with the first and second lenses such that when the lens adjuster is engaged, the position of the first and second lenses can be adjusted.

17. The virtual reality headset system of claim 1 wherein the lens module further comprises one or more lens modifiers and wherein the lens modifiers are positioned to cooperate and optically align with the lenses.

18. A modular virtual reality headset system comprising:
a. a frame assembly capable of being customized and assembled by the user, wherein the frame assembly comprises a support module, a device module defining a dock and configured to receive a mobile device and configured to removably attach to the support module, and a lens module configured to removably attach to the support module and the device module, wherein the lens module comprises at least one lens removably attached to a lens plate;
b. a comfort module removably attached to the support module on a surface of the comfort module configured to cooperate with a user's face;
c. control and processing components housed in the frame assembly;
d. wireless communication components housed in the frame assembly and configured to communicate wirelessly with at least a mobile device positioned in the dock of the frame assembly;
e. one or more locks for securing the mobile device in the dock of the frame assembly; and
f. one or more straps removably attached to the frame assembly.

19. The modular virtual reality headset system of claim 18 wherein the support module comprise one or more support module extensions, wherein the device module comprises one or more device module extensions configured to substantially nest within the support module extensions, and wherein the lens module comprises one or more lens module extensions configured to substantially nest within the device module extensions.

20. The modular virtual reality headset system of claim 18 wherein the lens module comprises a first lens, a second lens, and one or more lens modifiers, wherein the first and second lenses removably secure to the lens plate and wherein the lens modifiers removably secure to the first and second lenses.
